(19) United States
(12) Patent Application Publication
(10) Pub. No.: US 2002/0194034 A1
(43) Pub. Date: Dec. 19, 2002

(54) Method and apparatus for automating structured settlements

(76) Inventors: W. Campbell Mears JR., Andover, MA (US); Viren Patel, Salem, NH (US)

Correspondence Address: Peter B. Sorell, Esq., Brown Rudnick Berlack Israels LLC, One Financial Center, Boston, MA, 02111, US

(21) Appl. No.: 10/074,750

(22) Filed: Feb. 13, 2002

Related U.S. Application Data
(60) Provisional application No. 60/268,477, filed on Feb. 13, 2001.
(60) Provisional application No. 60/268,301, filed on Feb. 13, 2001.

(51) Int. Cl. G06F 17/60

(52) U.S. Cl. 705/4

(57) ABSTRACT

An automated method provides optimized collection, maintenance and communication of data between parties involved in structured financial settlements. Software methods allow broker companies and life companies to have access to updated client information and rate information in order to minimize the cost of the structured settlement process. Software collects all necessary data and performs automatic structured settlement quotations. An online service provides access to remote software and databases. Synchronization of data and business rules is achieved using a standardized protocol.

### CROSS REFERENCE TO RELATED APPLICATIONS

The present invention claims priority under 35 U.S.C. 119(e) to U.S. Provisional Application No. 60/268,477 filed on Feb. 13, 2001 which is hereby incorporated by reference in its entirety and U.S. Provisional Application No. 60/268,301 filed on Feb. 13, 2001 which is hereby incorporated by reference in its entirety.

### FIELD OF THE INVENTION

The present invention relates generally to the field of financial services and more particularly to the field of structured settlements.

### BACKGROUND OF THE INVENTION

Structured settlements are well known in the field of insurance claims. Often, these claims involve the disposition of personal injury settlements and workers' compensation settlements. In addition, the use of structured settlements is becoming increasingly popular to settle environmental coverage disputes, property damage cases and various other disputes. Certain tax benefits have been established by the Internal Revenue Service for structured settlements. These settlements can be negotiated using a combination of up-front payments and subsequent periodic payments. The periodic payments are often funded using life insurance annuities.

Structured settlement annuities, including life insurance annuities are typically sold by a relatively small number of brokers. Contacts between the brokers and claimants are typically initiated via referrals from insurance claims personnel, third party administrators, attorneys, and other parties.

The brokers typically use various computer software products to assist them as they as advise their clients in the claim settlement process. However, currently available software products that are typically used by brokers are not well suited for arranging and finalizing structured settlements. These software products are typically run on individual PCs or on local networks. Annuity rate changes are communicated via rate codes that are typically distributed via fax, letter, or in some cases on the life insurer's website. The claim settlement process is often performed with limited information which combined with the currently available software may not sufficiently satisfy the needs of the client.

Significant manual information gathering efforts are often necessary to supplement the currently available software in order to meet the needs of settlement clients and the various professionals involved in the settlement process. These efforts including gathering all necessary information to issue a life insurance policy, and producing and distributing multiple documents are excessively time consuming thereby increasing costs and inconveniencing the brokers, clients and other parties involved in the settlement process.

Another problem with prior art systems of structured settlements arises because the average case size in the structure market is declining. The cost to process a small case is essentially the same as the cost to process a large case so average margins for brokers and life insurance companies have also been declining. Increasingly, brokers and life insurance companies are choosing not to handle smaller cases and potential revenue in the structure market is being lost.

Still another problem with the prior art systems arises because claims that are potential candidates for structured settlements are generally referred to brokers through professional interpersonal relationships. This requires either a broker or a claims person to contact the other to refer or request a case. Issues as simple as the parties being busy or unavailable can keep high-probability structure candidates from being properly referred. These missed opportunities and a lack of incentive to refer or request smaller cases detrimentally affects broker and life insurance company revenue.

### SUMMARY OF THE INVENTION

The present invention overcomes the disadvantages of the prior art by providing software and related business methods for initiating, processing and finalizing structured settlements in a manner that streamlines information gathering procedures and provides a cost-effective procedure to meet the needs of the professionals involved in structured settlements and their clients.

According to an illustrative embodiment of the present invention, computer software allows users to track all case information simply and logically. Desirably, an illustrative embodiment of the software interfaces with the internet to access various sources for gathering information. The users can associate an unlimited number of claimants, clients, attorneys, insurers, etc. to a case and track all information relating to those parties. Users can also manage this information, share it and use it to generate quotes, proposals and other documents.

The present invention reduces the cost to produce the smaller cases which are becoming more prevalent in the structured settlement industry. Processing costs are reduced by interconnecting participants and using computers to automate the more labor intensive tasks. The cost advantages increase potential revenue for brokers and insurance companies by making the numerous small cases more attractive.

The present invention also prevents missed opportunity costs by automatically identifying structured settlement candidates. Embodiments of the present invention interface with the various insurance company claims systems and use client-specified business rules to identify candidates. Embodiments of the present invention also provide the ability for claims organizations to distribute candidates to their brokers, manage disposition of cases and report periodic results. Candidate identification and tracking performed according to the present invention thereby provides substantial cost reductions as compared to prior art methods of manual identification and tracking of candidates.

### BRIEF DESCRIPTION OF THE DRAWINGS

The above and further advantages of the invention may be better understood from the following detailed description, in conjunction with the following figures, referred to herein and constituting a part hereof, wherein:

FIGS. 1A-1C are tables listing the various modules and their respective capabilities according to at least one embodiment of the present invention;

FIG. 2 is a schematic block diagram illustrating the relationship between the various modules and users according to at least one embodiment of the present invention;

FIGS. 3-18 are pictorial representations of interface screens used in illustrative embodiments of the present invention to create and update new case information;

FIGS. 19-31 are pictorial representations of interface screens used in illustrative embodiments of the present invention to maintain and manage diary functionality;

FIGS. 32-35 are pictorial representations of interface screens used in illustrative embodiments of the present invention to search for cases and contacts;

FIGS. 36-46 are pictorial representations of interface screens used in illustrative embodiments of the present invention to generate a quote;

FIGS. 47-54 are pictorial representations of interface screens used in illustrative embodiments of the present invention to generate and track documents;

FIG. 55 is a pictorial representation of an interface screen used in illustrative embodiments of the present invention to communicate with support, home office, clients, and vendors; and

FIGS. 56-61 are pictorial representations of interface screens used in illustrative embodiments of the present invention to generate reports.

### DETAILED DESCRIPTION

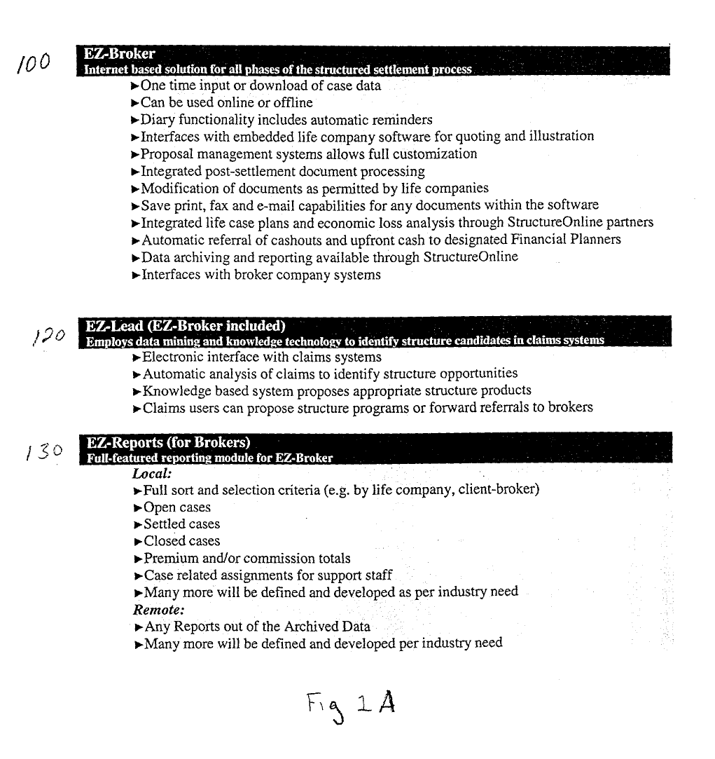

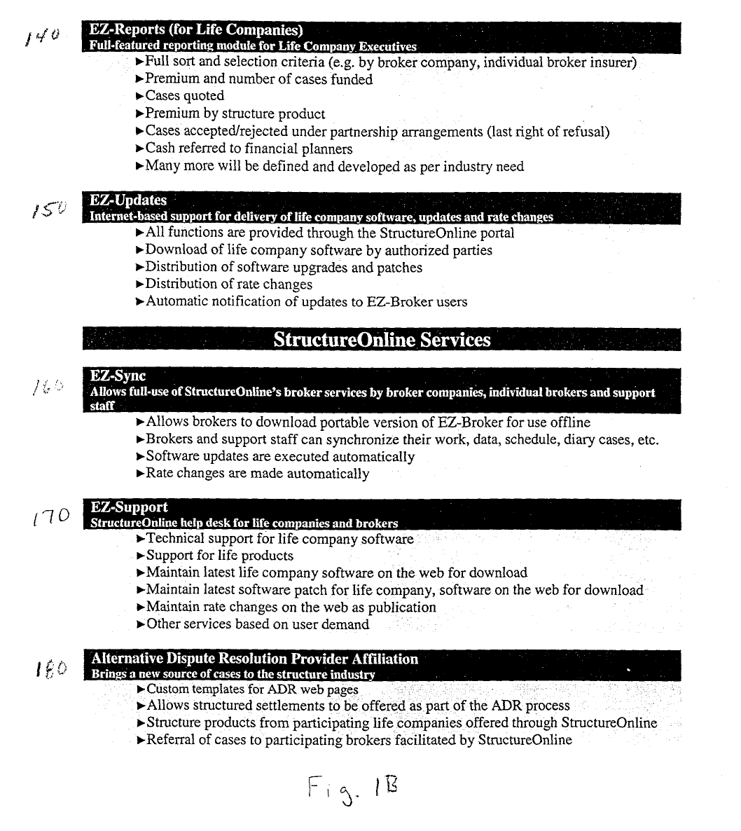

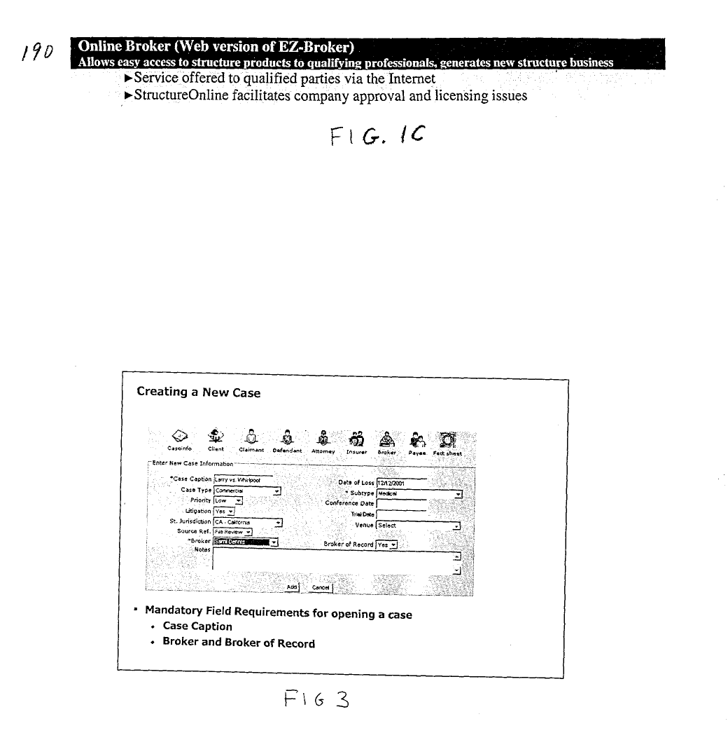

Referring to FIGS. 1-61 and the accompanying disclosure materials, the disclosed computer software includes programs that facilitate reduction of processing costs through interconnection of participants and the use of computers to streamline labor-intensive tasks. As shown in FIGS. 1-61 illustrative embodiments of the present invention communicate with claim systems and uses client's business rules to automatically identify structure candidates. Embodiments of the invention also provide the ability for the claims organization to distribute these candidates to its brokers, to manage the brokers' disposition of the cases and to report on periodic results. All of this is done automatically, at a fraction of what it costs to do it manually.

Various modules and embodiments of the present invention described herein can be used by customers outside of the traditional structured settlement marketplace. Such customers include alternative dispute resolution providers, claims service organizations, financial planners, attorneys and other companies in the financial services market.

By automating administrative processes, the present invention allows structure professionals to allocate their skills to resolve claims. In addition, the method as described herein according to the present invention is designed to work with a client's existing systems. Software products related to the disclosed methods have been developed in an open architecture so that the integration into other systems is seamless.

The computer program disclosed herein as an illustrative embodiment of the present invention allows users to identify any party involved in a case as their client. For example, a client can be an insurer, an attorney, a TPA (third party adjustor) or another contact. If a client is involved in a case in another capacity (e.g., insurer, attorney), it will be tracked in both applicable areas of the program for that case.

According to an illustrative embodiment of the present invention a computer program hereinafter referred to as EZ-Broker and available from StructureOnline, Inc. of Salem, N.H., allows user to initiate a case; select a client, defendant, attorney, insurer, and broker; add claimant, payee and beneficiary formation to a case and print a fact sheet for a case.

In the illustrative embodiment, data is entered into EZ-Broker either by the broker user or by the broker's client, as a referral. Quoting is then performed using the actual life company software. EZ-Broker has a pull-down menu of life company quoting software from which the user selects a life company. When a life company is selected, its proprietary software is invoked, and the required data is transferred into it from EZ-Broker's database via XML. It is contemplated that life companies include, such as, for example, providers of annuities. The user then uses the life company software as it was designed to be used. When the user is finished running a quote with the life company software, he clicks a button which tells the life company software to transfer the data back to EZ-Broker, again this uses XML. All unique structured settlement proposals created in this way are saved in EZ-Broker, associated with a case, and are given unique proposal ID's.

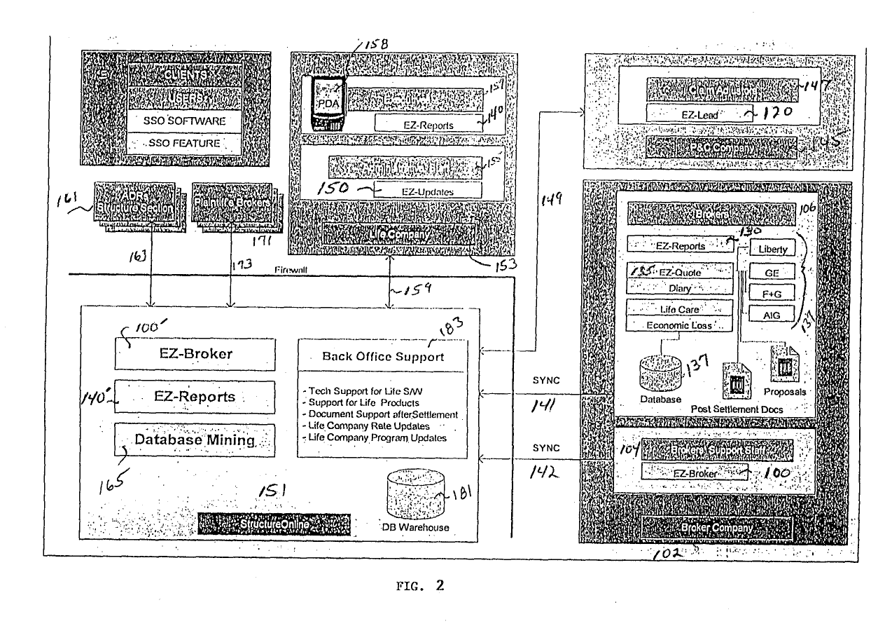

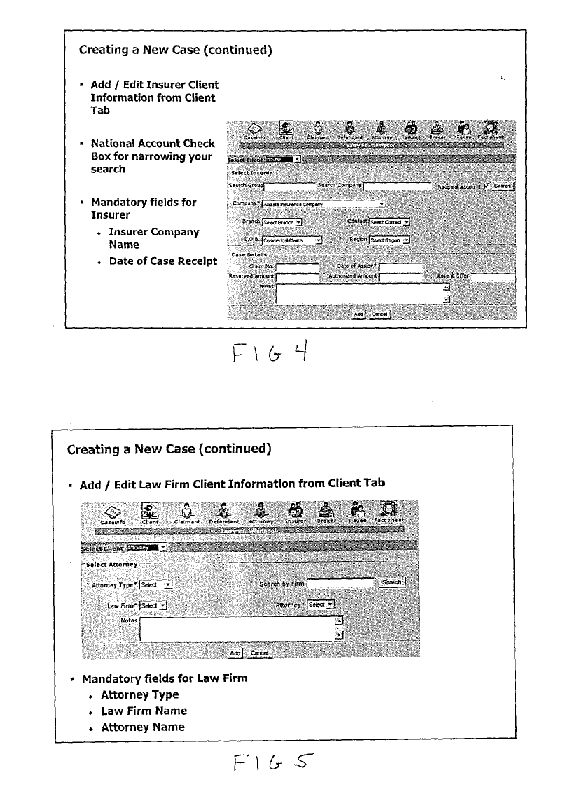

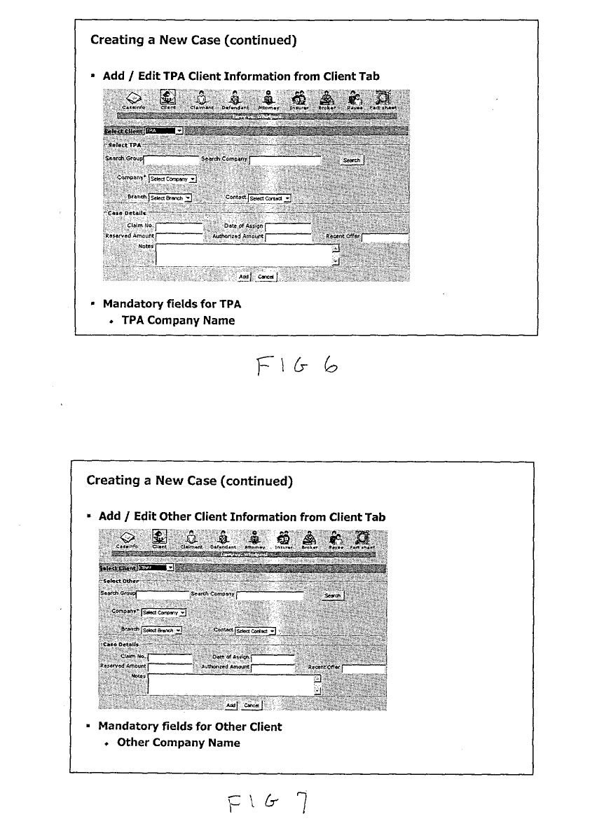

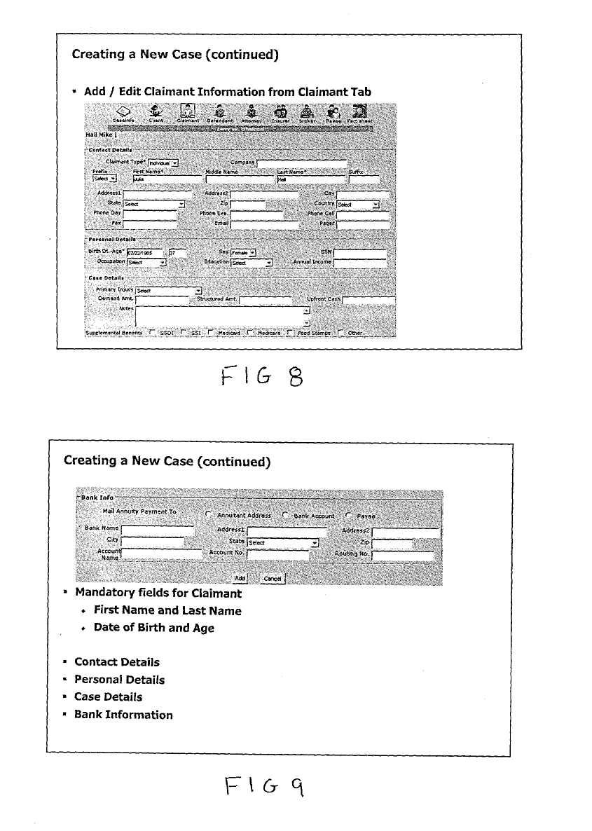

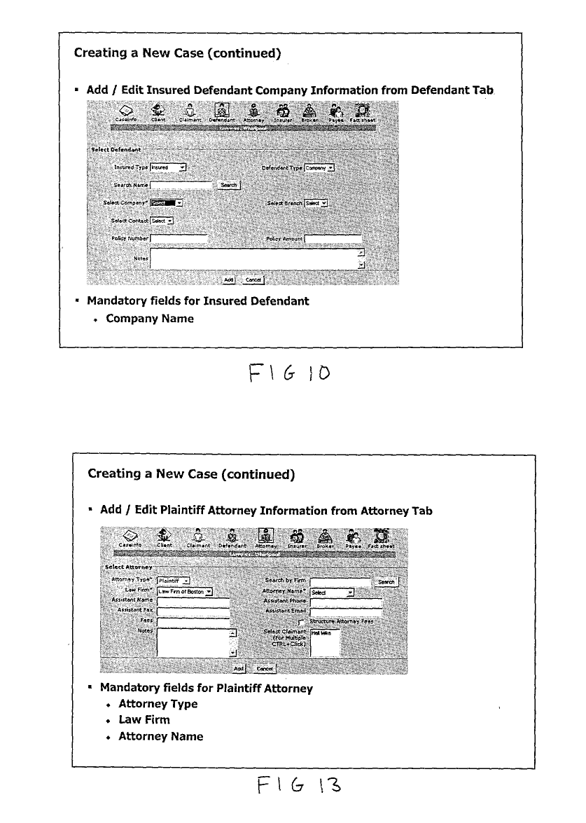

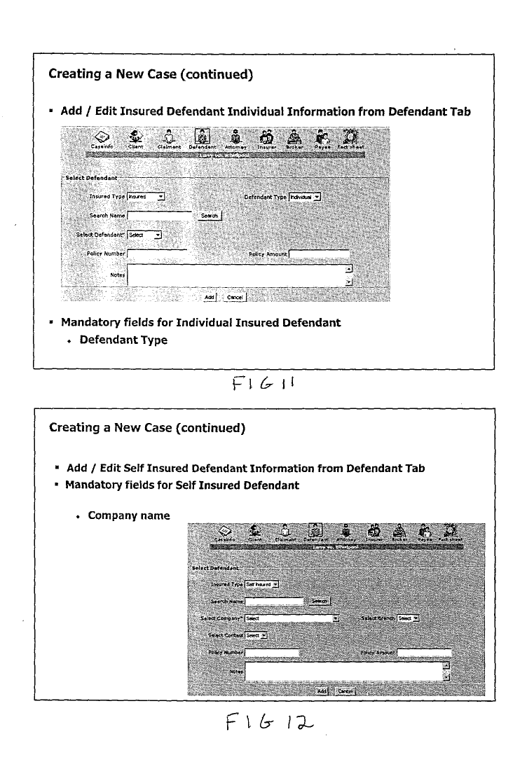

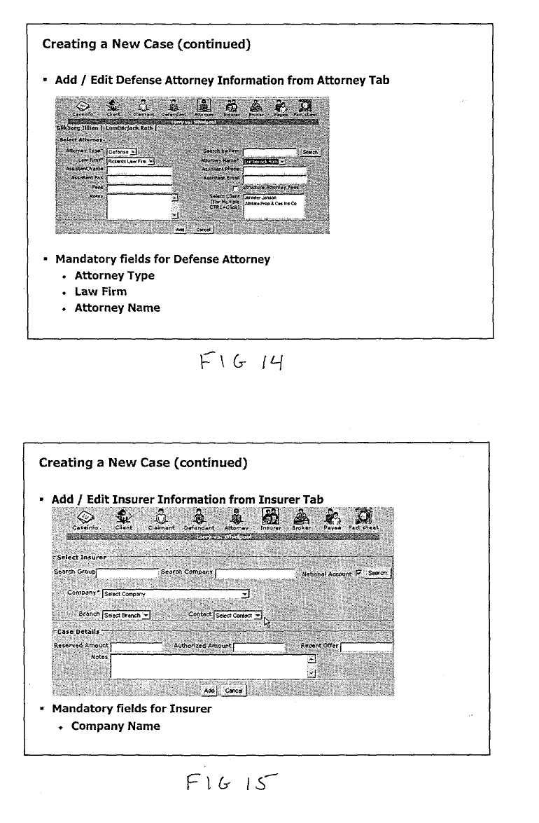

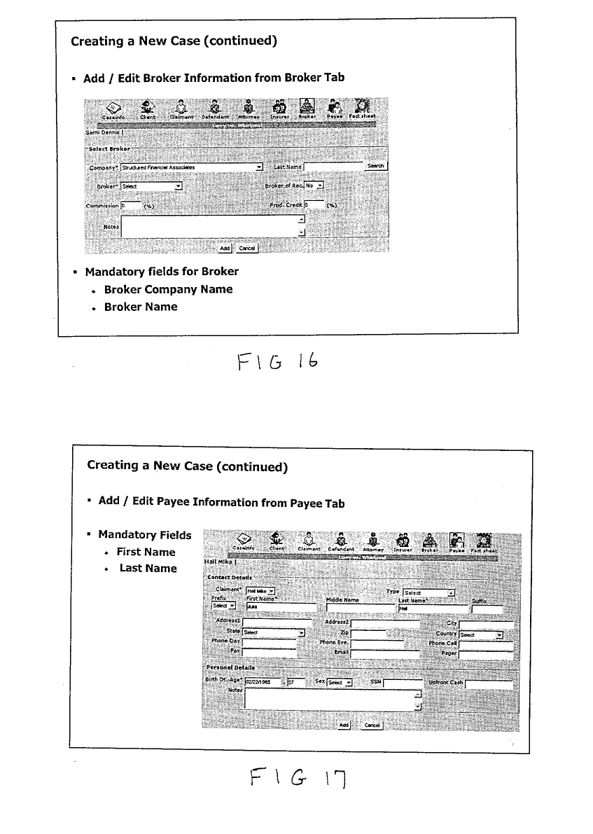

To initiate a case, the user enters the following information: case caption, date of loss, case type and sub type, priority, conference date, whether or not a litigation has been initiated, trial date, state of jurisdiction, venue, source reference, broker, broker of record and notes. The case initiation process according to the invention can be better understood and appreciated by persons skilled in the art with reference to the exemplary interface screens illustrated in FIGS. 3-18. Users can easily update cases, select and update insurers, attorneys, TPAs, defendants and others as clients. Users also enter claimant information including company or individual name, address, date of birth, sex, social security number, occupation, level of education, annual income, primary injury, demand amount structured amount and upfront cash (if available), supplemental benefits, notes, mailing address for annuity payments, bank account number, bank address and routing number. In the exemplary embodiment, all claimants are automatically added to the list of payees by entering them into the computer software program. Although the invention is generally described in terms of a single claimant and defendant it should be understood that information relating to any number of claimants and defendants can be processed according to the present invention.

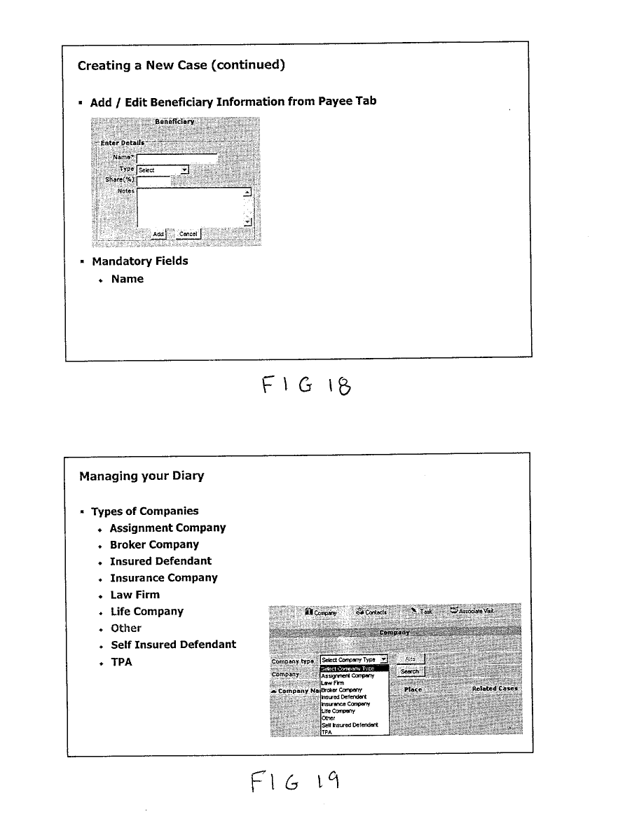

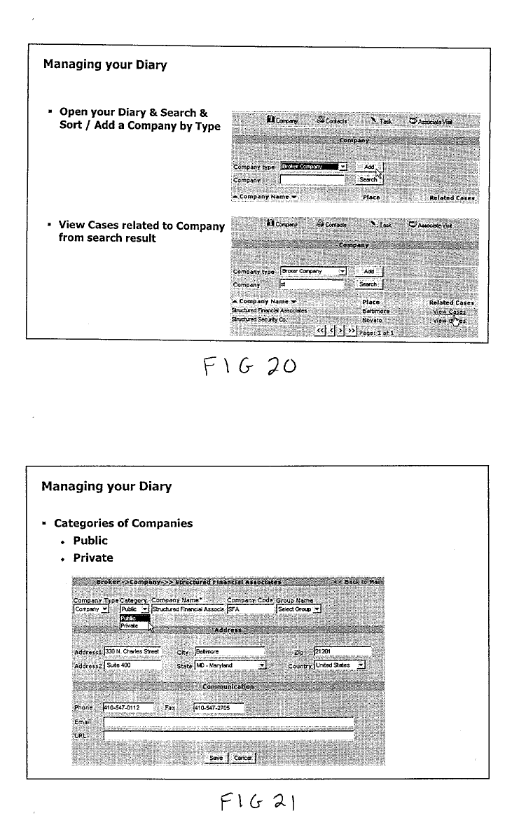

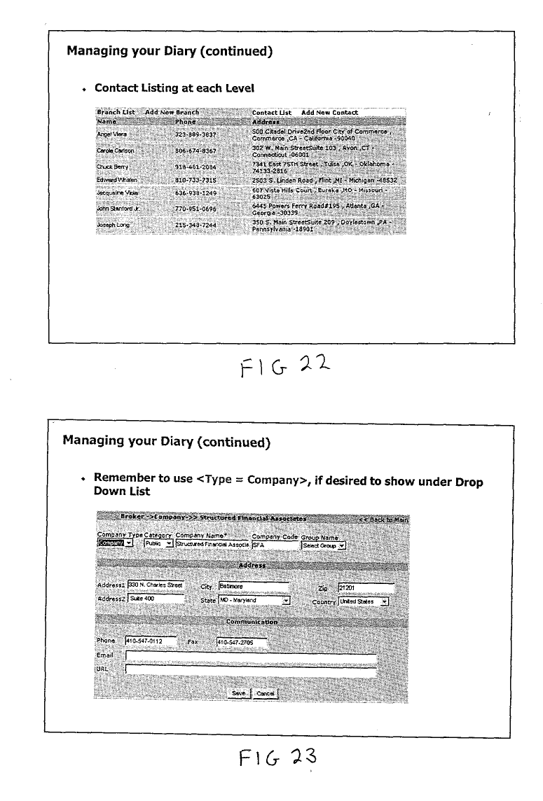

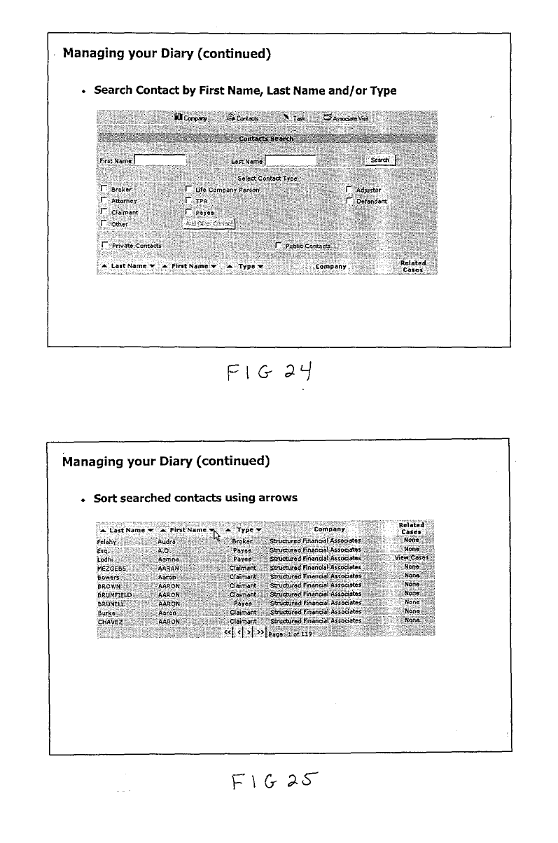

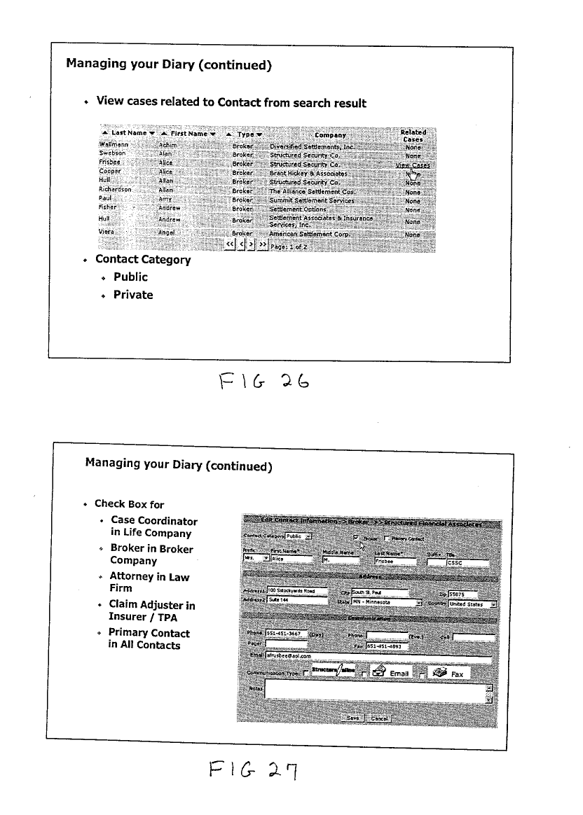

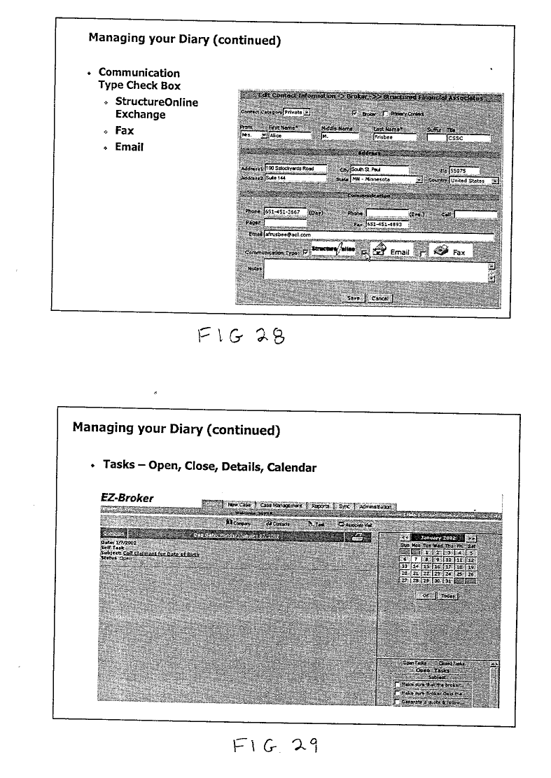

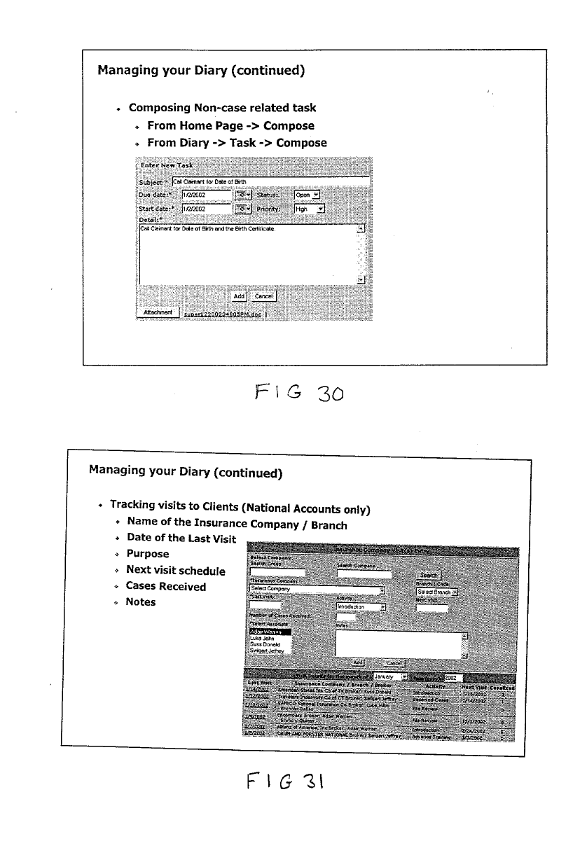

A diary module in the exemplary computer program allows the user to track, manage and share tasks, contacts and other items, such as client office visits. The diary module allows users to add and/or update company and contact information via entering data into the computer software program; add contact information at any level of a company hierarchy; view life company and assignment company information; view cases related to a company or contact; create a self or non-case related task and track associate visit information. The diary module can be better understood and appreciated by persons skilled in the art with reference to Exemplary user interfaces screens for maintaining and managing diary functionality as shown in FIGS. 19-31.

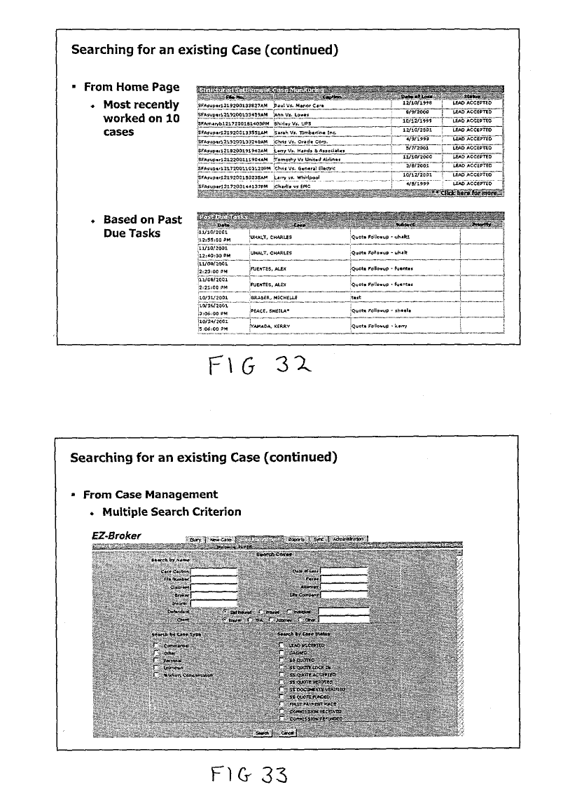

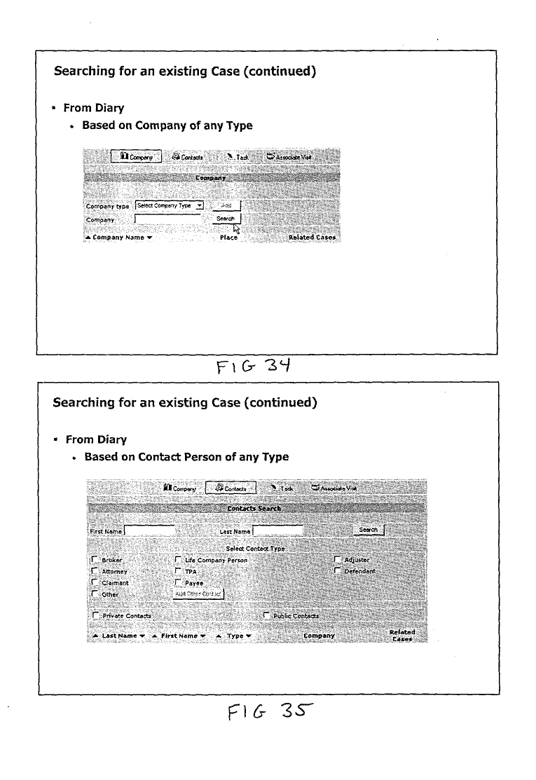

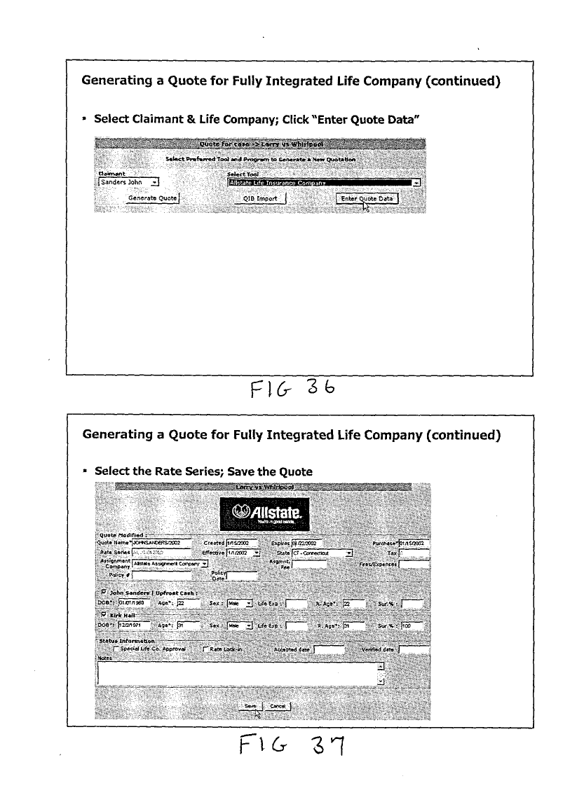

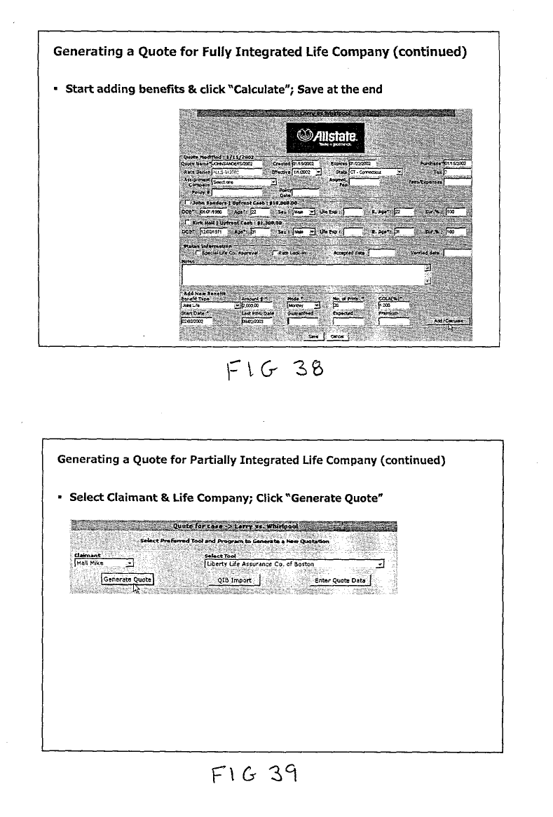

A case management module of the exemplary computer program allows users to search for a case or cases using a wide variety of search criteria. Once a case is located the users can click on its caption to manage data and perform tasks. Cases can also be looked up from the exemplary computer program's home page. For example, an illustrative case management module allows users to search an existing case from a list of past due tasks; search an existing case from a structured settlement case monitoring list; search for contacts and search an existing case in a case management database using case caption, file number, claimant, broker, insurer, defendant, client, date of loss, payee, attorney, and/or life company information. Users can also search for contacts from within the diary module, discussed above. The case management module according to illustrative embodiments of the present invention can be better understood and appreciated by persons skilled in the art with reference to FIGS. 32-35 which illustrate user interface screens of an exemplary case management module.

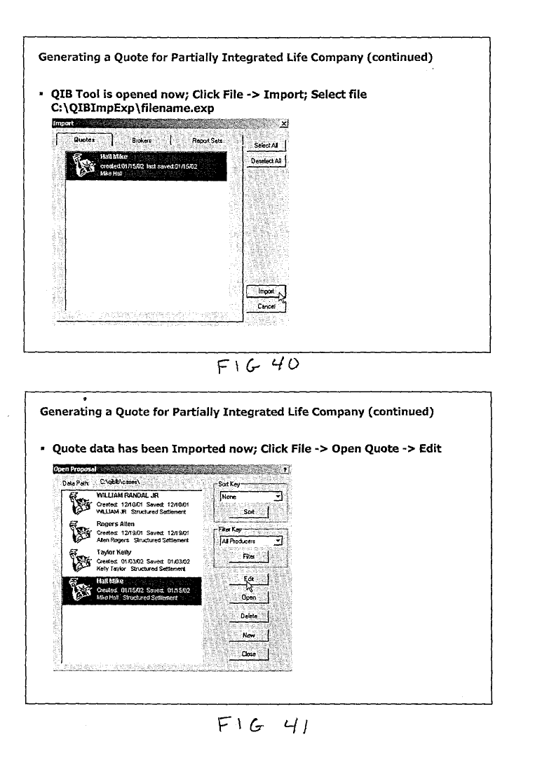

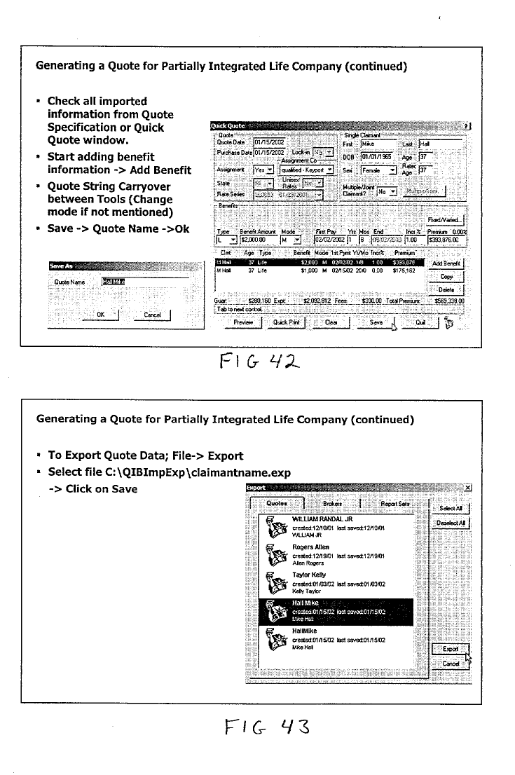

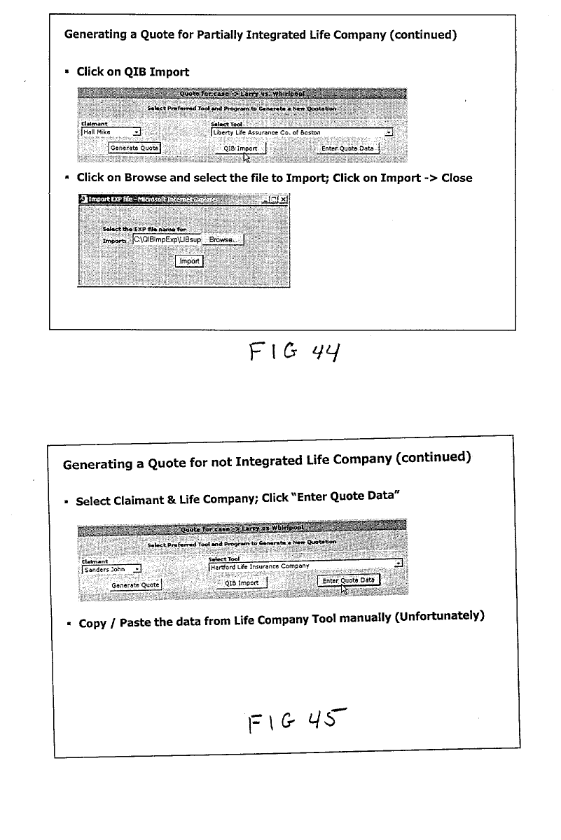

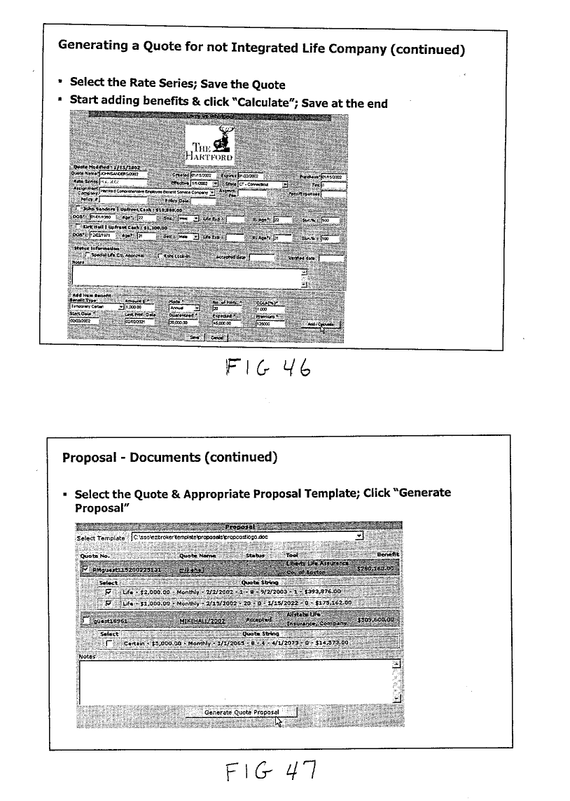

The exemplary program allows users to produce structured settlement quotations using third-party illustration software. The mode of producing quotations allows a single third-party software program to be selected from a drop down menu of the program. The drop down menu displays the third-party software programs which can be selected therefrom. This is a significant benefit to the providers of that software. This unique feature of the present disclosure allows providers' to illustrate their unique selling points from the quotation process. Further, the program permits a user to store and use those quotations in proposal and other documents. Quotations are run using fully-integrated, partially-integrated and non-integrated software depending on the insurance company whose products are being quoted. Users can easily generate a quote using fully-integrated software; generate a quote using partially-integrated software or generate a quote using non-integrated software. FIGS. 36-46 depict user interface screens used in an illustrative embodiment of the present invention to perform automated quotations.

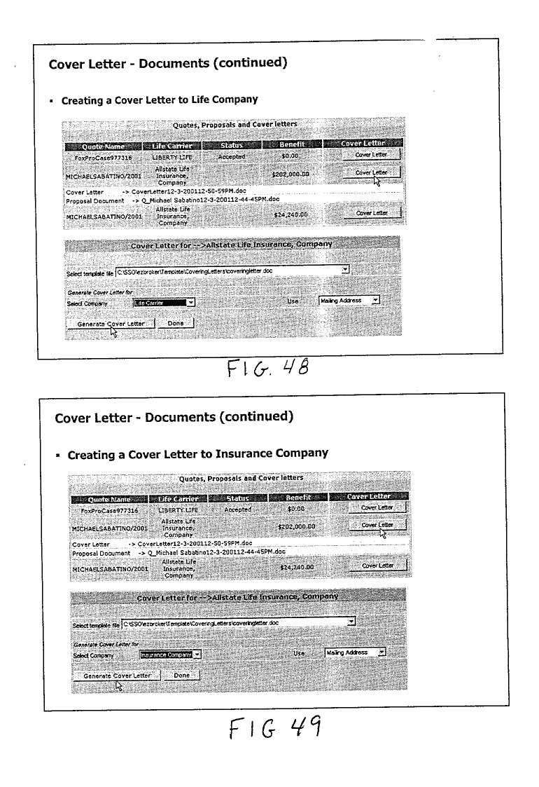

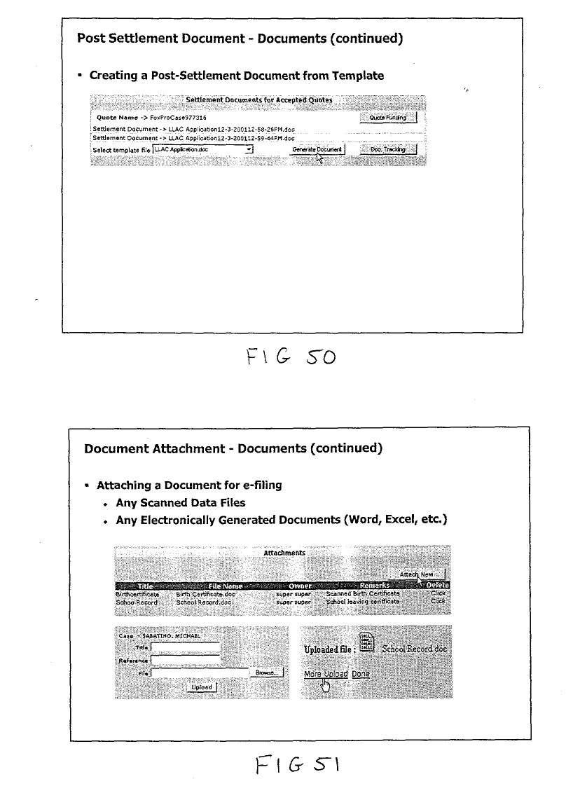

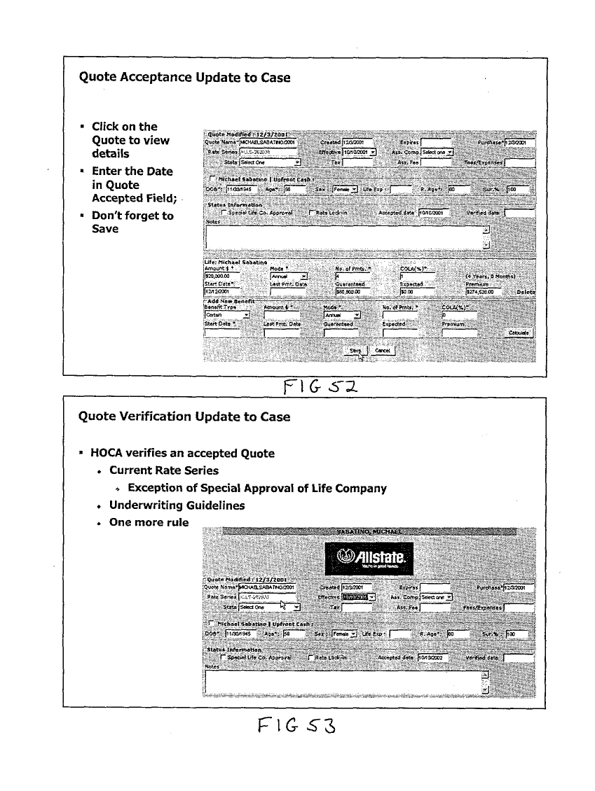

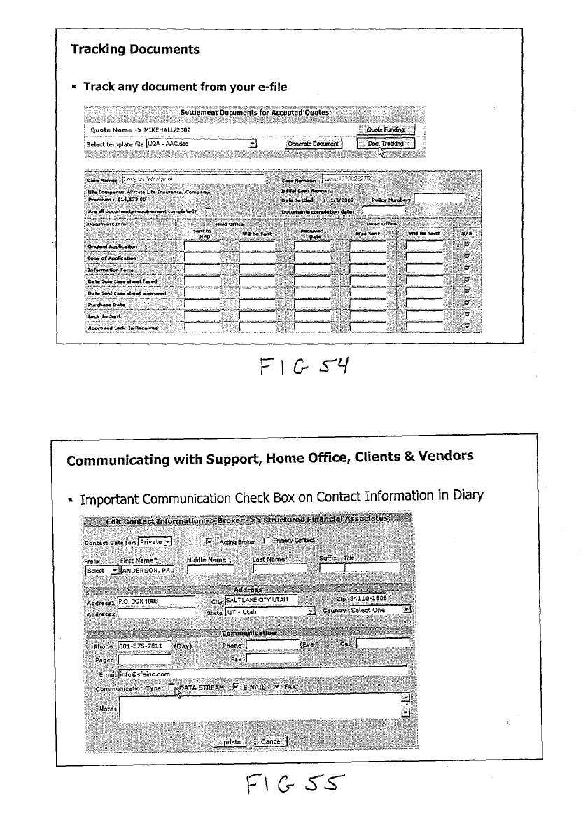

The exemplary computer program allows users to generate proposals, closing paperwork and other documents automatically, using data previously input. These documents can be managed, shared and stored in the system. Users can generate proposals and cover letters; generate settlement documents; attach documents to a case; track quote acceptance and verification; and track documents and their status. FIGS. 47-54 illustrate user interface screens used in illustrative embodiments of the present invention to generate and track documents automatically.

The exemplary computer program uses communication technology, such as, for example, publicly accessible networks, such as the Internet, global computer network, or more secure private networks, such as an internal company network, to allow users to share case and other information securely and efficiently over the Internet. Users can communicate through an internal system of a first company with any other user on that first companies' system. Users can also communicate with other users and individuals outside the first company, such as, for example, communicating with a second company, multiple companies, outside entities, etc. For example, users can easily compose tasks and follow-ups; share tasks; update tasks and access case and task history using the communication capabilities of the present invention. FIG. 55 illustrates an exemplary user interface screen for communicating with support, home office, clients and vendors.

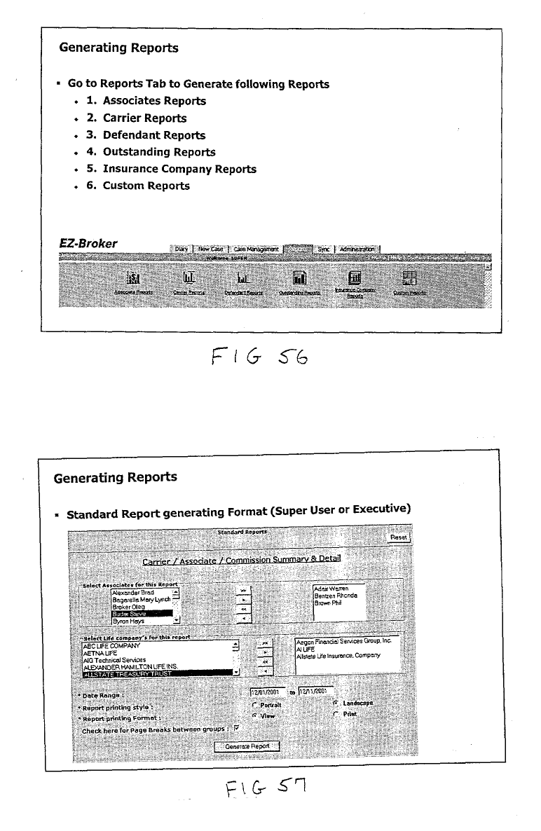

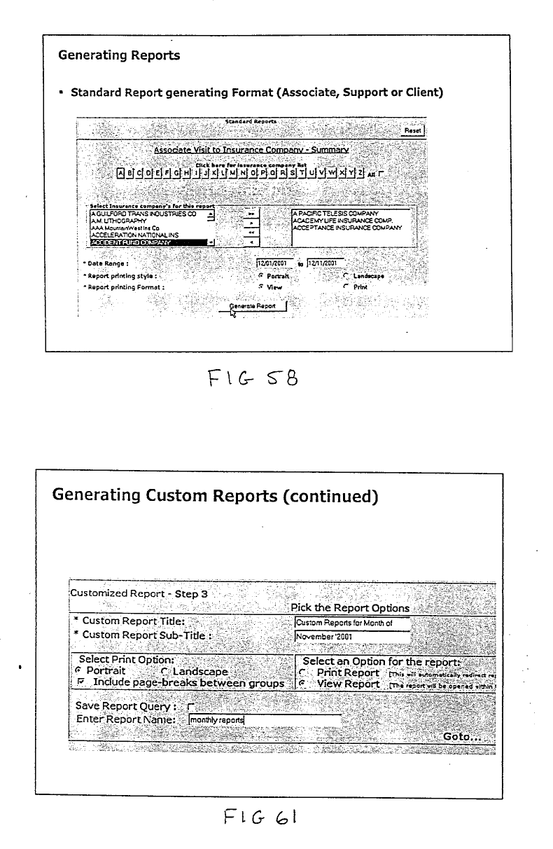

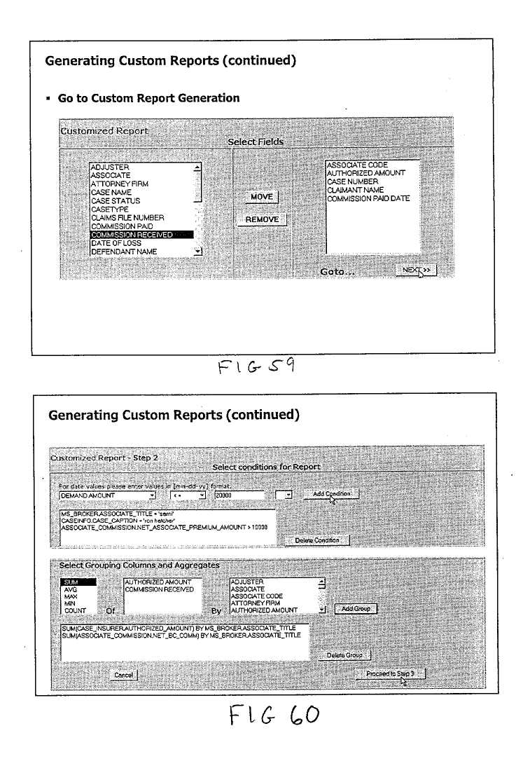

The exemplary computer program includes a reporting engine which allows users to report on any data in the database. Once information is entered, it can be reported on, giving users real-time access to activity and statistics. In addition to a number of pre-programmed reports, the exemplary computer program includes a full-featured custom reporting engine that allows users to design and save new reports. For example, users can easily generate standard reports and generate custom reports. FIGS. 56-61 are illustrate user interface screens used in exemplary embodiments of the present invention to automate report generation.

An illustrative embodiment of the present invention is described in more detail with reference to the various modules as listed in FIGS. 1A-1C. An EZ-Broker module 100 provides an internet based method for all phases of the structured settlement process. The various features of the EZ-Broker module include one time input or download of case data; online or offline use; diary functionality including automatic reminders; interfacing with embedded life company software for quoting and illustration; proposal management system with full customization; integrated post-settlement documentation processing; modification of documents as permitted by life companies; save, print, fax and e-mail capabilities for all documents within the software; integrated life case plans and economic loss analysis; automatic referral of cashout and upfront cash to designated financial planners; data archiving and reporting; and interfacing with broker company systems.

An EZ-Lead module 120 employs data mining and knowledge technology to identify structure candidates in claims systems. The EZ-Lead module 120 provides an electronic interface with claims systems; automatic analysis of claims to identify structure opportunities; and knowledge based systems that propose appropriate structure products. The EZ Lead module 120 also allows claims users to propose structure programs or forward referrals to brokers.

An EZ-Reports module 130 integrates with the EZ-Broker module 100. It is contemplated that module 130 may be integrated with various software. The EZ-Reports module 130 can be used locally to provide full sort and selection criteria and report open cases, settled cases, closed cases, premium and/or commission totals, and also to report case related assignments for support staff. The EZ-Reports module 130 can be used remotely to provide any reports from archived data.

Referring now to FIG. 1B, an EZ-Reports module for life companies 140 provides a full featured reporting module for live company executives. The EZ-Reports module for life companies 140 provides data features including full sort and selection criteria; premium and number of cases funded; cases quoted; premium by structure product, cases accepted/rejected under partnership arrangements, and cash referred to financial planners.

An EZ-Updates module 150 provides internet-based support for delivery of life company software, updates and rate changes. The EZ-Updates module provides functionality including all functions that are provided through a particular online portal (for example the StructureOnline portal provided by the Applicant, StructureOnline Inc.); downloading of life company software by authorized parties; distribution of software upgrades and patches; distribution of rate changes; and automatic notification of updates to EZ-Broker users.

An illustrative embodiment of the present invention also includes an EZ-Sync service 160 that allows full-use of online broker services (for example, online broker services provided by StructureOnline Inc.) by broker companies, individual brokers and support staff. The EZ-Sync service 160 allows brokers to download portable versions of EZ-Broker for offline use; allows brokers and support staff to synchronize their work; automatically executes software updates and changes rates.

An EZ-Support service 170 provides a help desk service for life companies and brokers. The EZ-Support service 170 includes technical support for life company software; support for life products; maintains latest life company software on the web for download; maintains latest software patches for life companies on the web for downloading; maintains rate changes on the web as a publication and may provide additional services upon user demand.

An Alternative Dispute Resolution Provider Affiliation service 180 brings a source of cases to the structure industry. This service customizes templates for ADR web pages; allows structured settlements to be offered as part of the ADR process; offers structures products from participating life companies; and refers cases to participating brokers.

Referring now to FIG. 1C, an online broker service 190 is an online web version of the EZ-Broker module 100 that allows easy access to structure products to qualifying professionals and generates new structure business. The online broker service 190 provides services to qualified parties via the internet.

The interrelationships between the various modules of the present invention are described with reference to FIG. 2. An exemplary Broker Company 102 includes Broker Support Staff 104 and Brokers 106. The Broker Support Staff 104 uses the EZ-Broker module 100 including any of the services described hereinbefore with reference to FIG. 1A. Brokers 106 can use the EZ-Reports module 130 as described with reference to FIG. 1 and the EZ-Quote module 135 to access a database 137 including rate information and proposals from various life companies 137. Communication links 141, 142 between the Broker Company 102 and an Online Service 151 allow communication of support data and updates to the Broker Company 102.

An exemplary P&C (property and casualty) Company 145 typically includes a plurality of Claim Adjustors 147. The Claim Adjustors 147 can use EZ-Lead module 120 to use data mining and knowledge technology to identify structure candidates as described hereinbefore. A communication link 147 between the P&C Company 145 and the Online Service 151 allows communication of support data and updates to the P&C Company 145.

An exemplary Life Company 153 typically includes Administrative Staff 155 and Executives 157. The Administrative Staff 155 can use the EZ-Updates module 150 to download life company software to authorized parties, distribute rate information and software updates as described hereinbefore. The Executives can use the EZ-Reports module 140 to analyze critical case related data using various criteria as described hereinbefore. Data accessed using the EZ-Reports module 140 can be provided to executives in a format appropriate for transfer to PDA devices 158 so that executives are allowed convenient access to information. A communication link 159 between the Life Company 153 and the Online Service 151 allows communication of support data and updates to the Life Company 153.

Various Alternative Dispute Resolution services include a Structure Section 161 to provide their clients with structured settlements. These ADR Structure Sections 161 can communicate to the Online Service 151 via a communication link 163 in order to access an online version of EZ-Broker 100′, EZ-Reports 140,′ Database Mining 165 or various Back Office Support Services 167. Each of these online services are also available to the Plaintiff Broker's 171 through a communication link 173 and to Life Companies 153, the P&C Companies 145 and Broker Companies 102.

An exemplary Online Service 151 according to the present invention includes a Database Warehouse 181, Back Office Support Services 183, EZ-Broker services 100′, EZ-Reports services 140′ and Database Mining services 165. The Back Office services 183 include technical support for Life Company software, support for Life Products, document support after settlement, life company rate updates and life company program updates.

An exemplary embodiment of the present invention further includes synchronization services to exchange data using common communication standards. An example of this service is provided by the EZ-Sync Services available from Structure Online Inc. The synchronization services allow the various modules according to the present invention to communicate with each other and with additional modules while protecting privacy and confidentiality of the content.

Using a standard protocol, for example the protocol defined by StructureOnline, Inc., one system can exchange data with another system over a network with or without using postmaster services provided by StructureOnline Messaging Server (SOMS). The exemplary embodiment is described herein with reference to the StructureOnline standard protocol and the StructureOnline Messaging Server. In a closed environment, when System A wants to communicate with System B, it will ask SOMS to process a request to System B and in turn, System B will initiate a connection to System A and receive limited or full data based on business rules defined between two systems. In an open environment, when System A wants to communicates with System B, it will communicate directly with System B and both systems will exchange information based on defined business rules for data exchange. Communication or data exchange business rules may reside on either System A or System B or on SOMS. The communication to and from systems could be either encrypted or not based on the system preferences. The communication may or may not use VPN based on user preferences. Systems could be in front of or behind Internet or Intranet Firewalls. Among electronic data exchange, SOMS also provides an interface between legacy means of communication methods like fax or emails and various systems for information exchange. The illustrative embodiment of the present disclosure, described as the EZ Sync service maintains data portability in internet, wired or stand-alone environments.

Although the present invention is described herein in terms of exemplary steps in an automated settlement structuring process, persons skilled in the art should understand that any number of the illustrative steps may be deleted and further steps may be added to provide varying interfaces and optional functionality without departing from the spirit and scope of the present invention.

It will be understood that various modifications may be made to the embodiments disclosed herein. Therefore, the above descriptions should not be construed as limiting, but merely as exemplification of the various embodiments. Those skilled in the art will envision other modifications within the scope and spirit of the appended claims.

What is claimed is:

1. A method of automating structured settlements including the steps of:
collecting and updating candidate data required to identify potential structure candidates; collecting and updating financial data required to structure settlements;
computing structured settlement quotations using said candidate data and said financial data and integrated third-party quotation programs; and
communicating said candidate data, said financial data and said quotations to structured settlement professionals.

2. The method according to claim 1 wherein said steps of collecting data and communicating data are performed via an online service.

3. The method according to claim 1 wherein said step of collecting data is automated by use of local software.

4. The method according to claim 2 wherein said online service includes broker programs for storing and downloading case data, maintaining diary functionality, and providing online reports.

5. The method according to claim 2 wherein said financial data is entered into a database by a broker.

6. The method according to claim 2 wherein said candidate data is entered into a database by a broker.

7. The method according to claim 2 wherein said financial data is entered into a database by a broker's client.

8. The method according to claim 2 wherein said third party quotation programs comprise life company quotation software.

9. The method according to claim 1 further comprising a step of selecting from said third party quotation programs on a menu.

10. The method according to claim 9 further comprising the step of invoking said third party quotation program and transferring data required by said third party quotation program to said third party program quotation program from a database of said financial data.

11. The method according to claim 10 wherein said transfer step is performed using XML.

12. The method according to claim 10 further comprising the step of transferring data back from said life company software to said database after a quotation process has been performed.

13. The method according to claim 12 further comprising the step of saving proposals including quotation process result in a database using unique proposal identifiers.

14. The method according to claim 13 further comprising the step of performing additional quotation processes using proposals saved during said saving proposals step.

15. The method according to claim 3 further comprising the steps of:
saving data collected during said collecting steps; and using said data saved during said saving data step in a later automatic quotation process.

16. The method according to claim 15 further comprising the step of saving results from said automatic quotation process in a database.

17. An apparatus for automating the structured settlement process comprising:
a modular computer network including case source nodes, broker nodes, life company nodes and a server (postmaster) node wherein said broker, case source and life company nodes are in communication with each other and with said server node.

18. The apparatus according to claim 17 further comprising computer software executable on said server and case source nodes for collecting and maintaining candidate data required to identify potential structure candidates;
collecting and updating financial data required to structure settlements; and computing structured settlement quotations using said candidate data and said financial data.

19. The apparatus according to claim 17 wherein data is exchanged between said nodes using common data protocol, wherein said protocol allows communication between nodes without services of said server (postmaster) node.

20. A method of automating structured settlements including the steps of:
collecting and updating candidate data required to identify potential structure candidates;
collecting and updating financial data required to structure settlements;
computing structured settlement quotations using said candidate data and said financial data and integrated third-party quotation programs;
communicating said candidate data, said financial data and said quotations to structured settlement professionals;
wherein said steps of collecting data and communicating data are performed via an online service;
wherein said online service includes broker programs for storing and downloading case data, maintaining diary functionality, and providing online reports;
wherein said financial data is entered into a database by a broker;
wherein said third party quotation programs comprise life company quotation software;
selecting from said third party quotation programs on a menu;
transferring data required by said third party quotation program to said third party quotation program from a database of said financial data using XML;
transferring data back from said life company to said database after a quotation process has been performed;
saving proposals including quotation process results in a database using unique proposal identifiers; and
performing additional quotation processes using proposals saved during said saving proposals step.
